(19) United States
(12) Patent Application Publication
(10) Pub. No.: US 2010/0115365 A1
(43) Pub. Date: May 6, 2010

(54) SYSTEM AND METHOD FOR DATA TRANSMISSION

(75) Inventors: Ming-Hung Tao, Tainan City (TW); Ying-Chuan Hsiao, Jhubei City (TW)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Industrial Technology Research Institute

(21) Appl. No.: 12/604,688

(22) Filed: Oct. 23, 2009

Related U.S. Application Data
(60) Provisional application No. 61/110,677, filed on Nov. 3, 2008.

(51) Int. Cl. H04J 3/24; H04L 1/18; G06F 11/14

(52) U.S. Cl. 714/748; 370/475; 714/E11.131

(57) ABSTRACT

A method for a transmitter to transmit data represented by a plurality of service data units (SDUs). The method includes: generating, for a first transmission, a data block from one or more of the SDUs, or from one or more fragments of the SDUs; generating, based on a protocol, a protocol data unit (PDU) to include the data block; and transmitting the PDU.

### RELATED APPLICATIONS

This application is based upon and claims the benefit of priority from U.S. Provisional Patent Application No. 61/110,677, filed Nov. 3, 2008, the entire contents of which are incorporated herein by reference.

### TECHNICAL FIELD

This disclosure relates to systems and methods for data transmission in a wireless communication system.

### BACKGROUND

Automatic repeat request (ARQ) schemes have been widely used in wireless communication systems. Based on ARQ schemes, if a receiver does not correctly receive data from a transmitter in a communication system, the receiver may request the transmitter to retransmit the data.

FIG. 1 illustrates a method 100 for a transmitter to transmit data to a receiver based on a conventional ARQ scheme. Referring to FIG. 1, the transmitter generates a plurality of service data units (SDUs) 102, each including a piece of information to be transmitted. The transmitter then fragments each of the SDUs 102 to generate a plurality of ARQ blocks 104 each having a fixed size. For example, the plurality of ARQ blocks 104 are generated in a media access control (MAC) layer of the transmitter, and are sequentially numbered. Traditionally, the size of each of the ARQ blocks 104 is determined when the transmitter and the receiver establish a connection, and is fixed for the connection.

The transmitter may further encapsulate, based on a protocol, the ARQ blocks 104 into a protocol data unit (PDU) 106 with a header H and a cyclic redundancy check (CRC). In the illustrated example, the PDU 106 contains multiple SDUs. In other examples, a PDU may also contain a part of an SDU or an SDU. The transmitter may then generate a data burst 108 for the PDU 106 in a physical layer of the transmitter, and transmits the data burst 108 to the receiver.

The receiver receives the data burst 108 in a physical layer of the receiver. The receiver recovers the PDU 106 from the data burst 108, and further recovers the ARQ blocks 104 in a MAC layer of the receiver. As a result, the receiver receives the SDUs 102.

Based on the conventional ARQ scheme, the receiver then provides to the transmitter feedback information regarding reception of the ARQ blocks 104. For example, the receiver may send acknowledgement (ACK) signals to the transmitter, to indicate which ones of the ARQ blocks 104 have been correctly received. Also for example, the receiver may send negative acknowledgement (NACK) signals to the transmitter, to indicate which ones of the ARQ blocks 104 have not been correctly received. When the transmitter receives the NACK signals from the receiver, the transmitter retransmits the corresponding ARQ blocks.

As noted above, the size of each of the ARQ blocks 104 is determined when the transmitter and the receiver establish the connection, and is fixed for the connection. If the size of each of the ARQ blocks 104 is determined to be relatively small, overhead due to numbering of the ARQ blocks 104 and providing feedback may be relatively large for the communication system, since the transmitter and the receiver typically need to identify each of the ARQ blocks 104 based on the sequential numbering, and the receiver typically needs to send an ACK or NACK signal for each of the ARQ blocks 104. In addition, if the size of each of the ARQ blocks 104 is determined to be relatively small, communication throughput may also be limited.

Conversely, if the size of each of the ARQ blocks 104 is determined to be relatively large, the transmitter may use a relatively large number of padding bits to fill up a bandwidth granted for the connection, which may cause waste of bandwidth resources.

### SUMMARY

According to a first aspect of the present disclosure, there is provided a method for a transmitter to transmit data represented by a plurality of service data units (SDUs), comprising: generating, for a first transmission, a data block from one or more of the SDUs, or from one or more fragments of the SDUs; generating, based on a protocol, a protocol data unit (PDU) to include the data block; and transmitting the PDU.

According to a second aspect of the present disclosure, there is provided a transmitter to transmit data represented by a plurality of service data units (SDUs), comprising: a processor, the processor being configured to generate, for a first transmission, a data block from one or more of the SDUs, or from one or more fragments of the SDUs; generate, based on a protocol, a protocol data unit (PDU) to include the data block; and transmit the PDU.

According to a third aspect of the present disclosure, there is provided a method for a receiver to provide feedback information for data received from a transmitter, the data being represented by a plurality of protocol data unit (PDU) partitions from a PDU, the method comprising: sending, if not all of the PDU partitions are correctly received, a negative acknowledgment (NACK) to the transmitter, to indicate that not all of the PDU partitions are correctly received; and sending additional information to the transmitter to indicate which ones of the PDU partitions are correctly received.

According to a fourth aspect of the present disclosure, there is provided a receiver to provide feedback information for data received from a transmitter, the data being represented by a plurality of protocol data unit (PDU) partitions from a PDU, the receiver comprising: a processor, the processor being configured to send, if not all of the PDU partitions are correctly received, a negative acknowledgment (NACK) to the transmitter, to indicate that not all of the PDU partitions are correctly received; and send additional information to the transmitter to indicate which ones of the PDU partitions are correctly received.

According to a fifth aspect of the present disclosure, there is provided a method for a transmitter to transmit data to a receiver, the receiver including a buffer for receiving the data, the method comprising: accumulating a number of bytes for transmitted data after a first transmitted data block is not acknowledged by the receiver; suspending transmission of data, if the accumulated number of bytes is equal to or larger than a number of bytes determined based on a size of the buffer; determining a number of bytes to be subtracted and subtracting the determined number of bytes from the accumulated number of bytes, when receiving an acknowledgement by the receiver of the first transmitted data block; and resuming transmission of data, if the accumulated number of bytes after the subtraction is smaller than the number of bytes determined based on the size of the buffer.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 illustrates a method for a transmitter to transmit data to a receiver based on a conventional ARQ scheme.

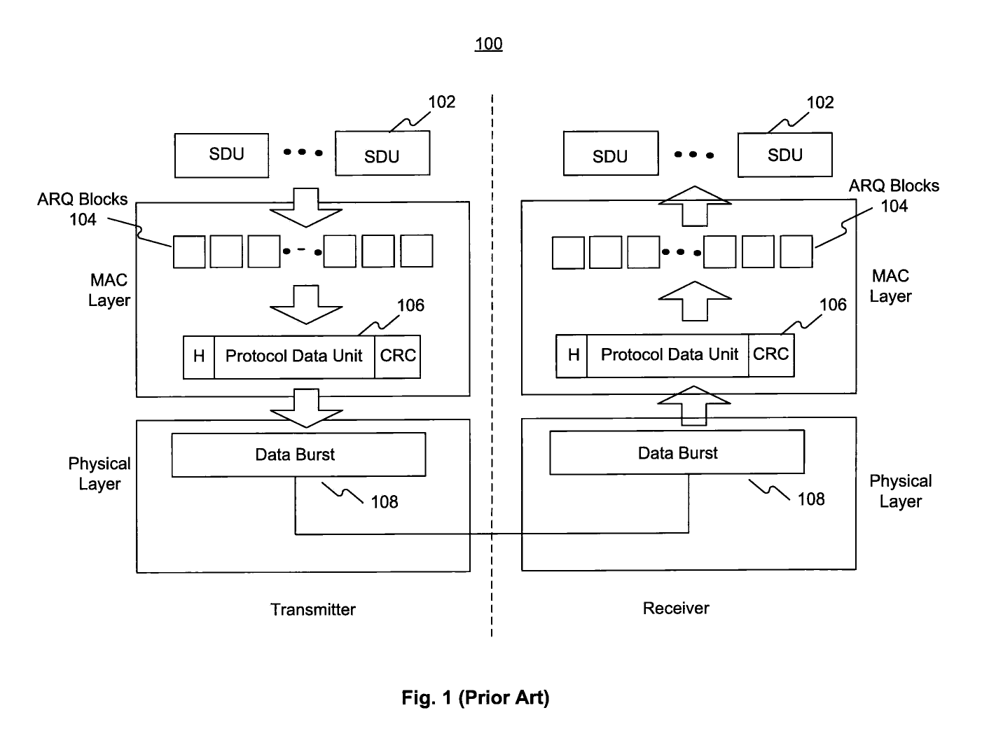

FIG. 2 illustrates a communication system, according to an exemplary embodiment.

FIG. 3 illustrates a method for a transmitter to transmit data to a receiver, according to an exemplary embodiment.

FIG. 4 illustrates a method for a transmitter to perform data retransmission, according to an exemplary embodiment.

FIG. 5 illustrates a method for a receiver to provide feedback information to a transmitter, according to an exemplary embodiment.

FIG. 6 illustrates a block diagram of a transmitter, according to an exemplary embodiment.

FIG. 7 illustrates a block diagram of a receiver, according to an exemplary embodiment.

### DESCRIPTION OF THE EMBODIMENTS

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of systems and methods consistent with aspects related to the invention as recited in the appended claims.

In exemplary embodiments, there are provided systems and methods for performing data transmission based on an automatic repeat request (ARQ) scheme. Based on the ARQ scheme, if a receiver does not correctly receive data from a transmitter, the receiver may request the transmitter to retransmit the data. The provided systems may operate in accordance with different standards, including, e.g., the IEEE 802.16 family of standards, the 3rd Generation Partnership Project (3GPP) standard, the High-Speed Packet Access (HSPA) standard, the Long Term Evolution (LTE) standard, etc.

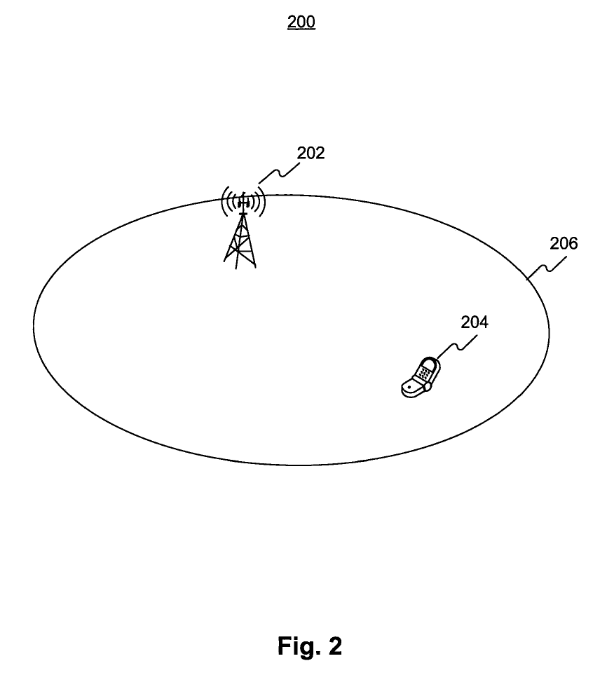

FIG. 2 illustrates a communication system 200, according to an exemplary embodiment. The communication system 200 includes a transmitter 202 and a receiver 204. For example, the transmitter 202 may be a base station, a relay station, or an access point. Also for example, the receiver 204 may be a mobile station or a subscriber station. The receiver 204 is located in a coverage area 206 of the transmitter 202, and the transmitter 202 is configured to transmit data to the receiver 204 using data transmission methods described below.

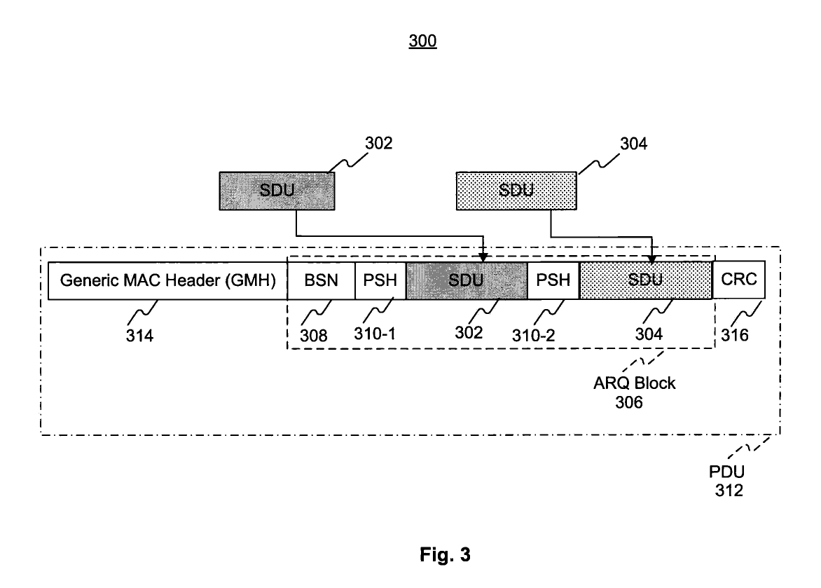

FIG. 3 illustrates a method 300 for the transmitter 202 (FIG. 2) to transmit data to the receiver 204 (FIG. 2), according to an exemplary embodiment. Referring to FIGS. 2 and 3, the transmitter 202 generates a plurality of service data units (SDUs), each including a piece of information to be transmitted. For illustrative purposes only, a first SDU 302 and a second SDU 304 are shown in FIG. 3.

In exemplary embodiments, the transmitter 202 is configured to generate a plurality of data blocks, referred to herein as ARQ blocks, each to include one or more of the plurality of SDUs. For example, the plurality of ARQ blocks are generated in a media access control (MAC) layer of the transmitter 202, and are sequentially numbered. In one exemplary embodiment, each of the plurality of ARQ blocks is assigned with a block sequence number (BSN) for identifying the ARQ block.

In exemplary embodiments, a number of SDUs included in an ARQ block may be determined by a bandwidth granted by the transmitter 202 for a communication connection between the transmitter 202 and the receiver 204. For example, if the granted bandwidth is relatively large, the number of SDUs included in an ARQ block may be relatively large. Also for example, if the granted bandwidth is relatively small, the number of SDUs included in an ARQ block may be relatively small. Therefore, for different granted bandwidths, a size of an ARQ block is variable.

In exemplary embodiments, the transmitter 202 is configured to pack or fragment an SDU. For example, if the granted bandwidth is not large enough for the transmitter 202 to include an integral number of SDUs, e.g., three SDUs, in one ARQ block, the transmitter 202 may fragment one of the three SDUs and pack the other two SDUs, to generate an ARQ block including one or more fragments of the one of the three SDUs and the other two SDUs. Also for example, the transmitter 202 may perform data packing by combining two or more SDUs or SDU fragments into one PDU and allowing the combined SDUs or SDU fragments to share a same MAC control header and a same CRC.

In one exemplary embodiment, shown in FIG. 3, the transmitter 202 generates an ARQ block 306 to include the first and second SDUs 302 and 304. The ARQ block 306 may further include an ARQ subheader 308 and packing subheaders (PSHs) 310-1 and 310-2, in addition to the first and second SDUs 302 and 304. For example, the ARQ subheader 308 may include the BSN for identifying the ARQ block 306 and control information for performing data retransmission. Also for example, the PSHs 310-1 and 310-2 may include packing information for the first and second SDUs 302 and 304, respectively.

In one exemplary embodiment, the transmitter 202 may generate the ARQ block 306 to include one or more fragments of a third SDU (not shown), in addition to the first and second SDUs 302 and 304. In such an embodiment, the ARQ block 306 may further include a fragmenting subheader (FSH) including fragmentation information for the one or more fragments of the third SDU.

In exemplary embodiments, the transmitter 202 further encapsulates the ARQ block 306 to generate, based on a protocol, a protocol data unit (PDU) 312. For example, the PDU 312 may include a PDU header 314 and a CRC 316, in addition to the ARQ block 306. Typically, the PDU 312 is generated in the MAC layer of the transmitter 202. Accordingly, the PDU header 314 may also be referred to as a generic MAC header (GMH).

Similar to the above description for generating the PDU 312, the transmitter 202 may generate a plurality of PDUs, each for one the plurality of ARQ blocks noted above. The transmitter 202 further transmits the plurality of PDUs to the receiver 204 as a first transmission. For example, the transmitter 202 may generate data bursts for the plurality of PDUs in a physical layer, and transmits the data bursts, which include the plurality of PDUs, to the receiver 204.

In exemplary embodiments, when the receiver 204 does not correctly receive an ARQ block, e.g., the ARQ block 306, of the first transmission, the receiver 204 may request the transmitter 202 to retransmit the ARQ block 306. The transmitter 202 may then transmit to the receiver 204 a retransmission PDU, which includes the ARQ block 306 with the corresponding packing or fragmenting information of the first transmission.

In one exemplary embodiment, a connection bandwidth granted for the retransmission may be smaller than the connection bandwidth granted for the first transmission. As a result, the ARQ block 306 may not be retransmitted as a whole due to the insufficient bandwidth. Accordingly, the transmitter 202 performs rearrangement of the ARQ block 306 for the retransmission. For example, the transmitter 202 fragments the ARQ block 306 into a plurality of data subblocks, referred to herein as ARQ subblocks, and transmits to the receiver 204 a plurality of PDU partitions each including one or more of the ARQ subblocks, as described below.

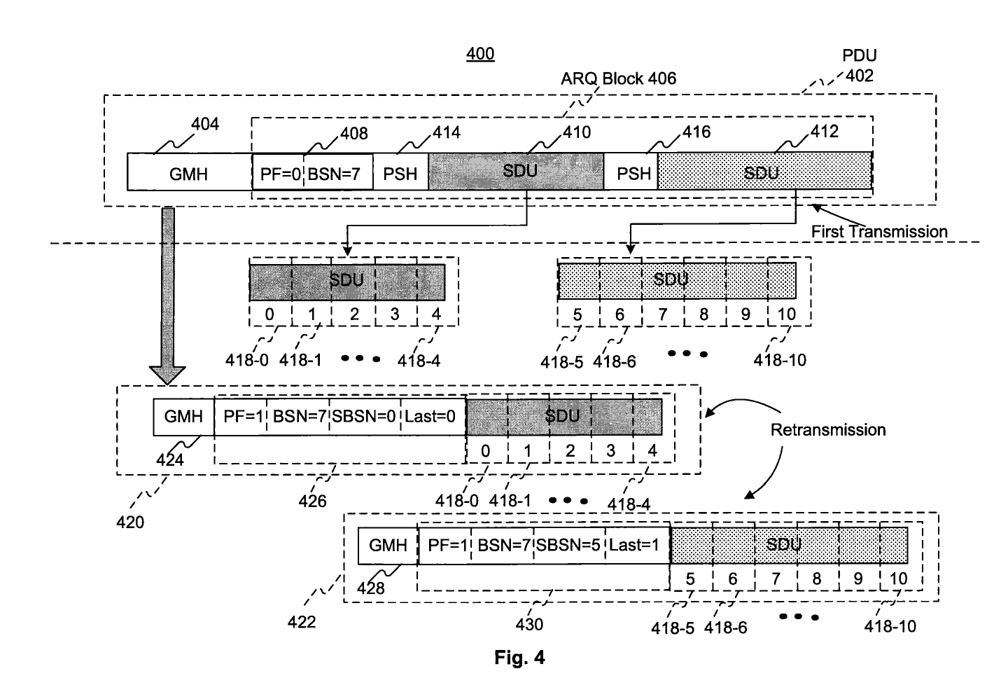

FIG. 4 illustrates a method 400 for the transmitter 202 (FIG. 2) to perform data retransmission, according to an exemplary embodiment. For example, the transmitter 202 transmits a PDU 402 for a first transmission, the PDU 402 including a GMH 404, an ARQ block 406, and a CRC (not shown). The ARQ block 406 further includes an ARQ subheader 408, first and second SDUs 410 and 412, first and second PSHs 414 and 416 for the first and second SDUs 410 and 412, respectively. Referring to FIGS. 2 and 4, in the illustrated embodiment, the receiver 204 does not correctly receive the ARQ block 406 for the first transmission and, hence, the transmitter 202 retransmits the ARQ block 406 to the receiver 204.

In exemplary embodiments, for the retransmission, the transmitter 202 fragments the ARQ block 406 by fragmenting the SDUs 410 and 412 into a plurality of ARQ subblocks 418-i. For example, the ARQ subblocks 418-i may each have a fixed size. Also for example, each of the ARQ subblocks 418-i is assigned with a subblock sequence number (SBSN) for being identified.

In the illustrated embodiment, the ARQ subblocks 418-i are assigned with the SBSNs 0, 1, 2, . . . , and 10, respectively. More particularly, the first SDU 410 is fragmented into the ARQ subblocks 418-0, 418-1, . . . , and 418-4, and the second SDU 412 is fragmented into the ARQ subblocks 418-5, 418-6, . . . , and 418-10.

In exemplary embodiments, the transmitter 202 generates a plurality of PDU partitions each including one or more of the ARQ subblocks 418-i for the retransmission. In one exemplary embodiment, shown in FIG. 4, the transmitter 202 generates a first PDU partition 420 including the ARQ subblocks 418-0, 418-1, . . . , and 418-4, and a second PDU partition 422 including the ARQ subblocks 418-5, 418-6, . . . , and 418-10. In the illustrated embodiment, the first PDU partition 420 includes the ARQ subblocks from the first SDU 410, and the second PDU partition 422 includes the ARQ subblocks from the second SDU 412. In other embodiments, ARQ subblocks from different SDUs may also be included in a PDU partition.

In one exemplary embodiment, the first PDU partition 420 further includes a GMH 424 and an ARQ subheader 426, in addition to the ARQ subblocks 418-0, 418-1, . . . , and 418-4. The ARQ subheader 426 may include a partition flag (PF) indicating whether the ARQ subblocks in the PDU partition 420 are partitioned from an original ARQ block for a first transmission, the BSN of the original ARQ block, and the SBSN of the first one of the ARQ subblocks in the PDU partition 420, i.e., the ARQ subblock 418-0. In the illustrated embodiment, PF=1 represents that the ARQ subblocks in the PDU partition 420 are partitioned from an original ARQ block, i.e., the ARQ block 406; BSN=7 represents that the BSN of the original ARQ block 406 is 7; SBSN=0 represents that the SBSN of the first one of the ARQ subblocks in the PDU partition 420 is 0. The ARQ subheader 426 may further include a last partition indicator (Last) indicating whether the PDU partition 420 includes the last one of the ARQ subblocks in the original ARQ block 406, i.e., the ARQ subblock 418-10. Because the PDU partition 420 does not include the ARQ subblock 418-10, Last=0.

Similarly, the second PDU 422 further includes a GMH 428 and an ARQ subheader 430, in addition to the ARQ subblocks 418-5, 418-6, . . . , and 418-10. The ARQ subheader 430 may include a partition flag (PF) indicating whether the ARQ subblocks in the PDU partition 422 are partitioned from an original ARQ block, the BSN of the original ARQ block, and the SBSN of the first one of the ARQ subblocks in the PDU partition 422, i.e., the ARQ subblock 418-5. In the illustrated embodiment, PF=1 represents that the ARQ subblocks in the PDU partition 422 are partitioned from an original ARQ block, i.e., the ARQ block 406; BSN=7 represents that the BSN of the original ARQ block 406 is 7; SBSN=5 represents that the SBSN of the first one of the ARQ subblocks in the PDU partition 420 is 5. The ARQ subheader 430 may further include a last partition indicator (Last) indicating whether the PDU partition 422 includes the last one of the ARQ subblocks in the original ARQ block 406, i.e., the ARQ subblock 418-10. In the illustrated embodiment, because the PDU partition 422 includes the ARQ subblock 418-10, Last=1.

In exemplary embodiments, the receiver 204 provides to the transmitter 202 feedback information regarding whether an ARQ block is correctly received, for requesting data retransmission. For example, if the receiver 204 correctly receives the ARQ block 306 (FIG. 3) of a first transmission, the receiver 204 may send an acknowledgment (ACK) signal to the transmitter 202, to indicate that the ARQ block 306 has been correctly received. If the receiver 204 does not correctly receive the ARQ block 306 for the first transmission, the receiver 204 may send a negative acknowledgment (NACK) signal to the transmitter 202, to indicate that the ARQ block 306 has not been correctly received.

In one exemplary embodiment, the receiver 204 provides feedback information for a plurality of PDUs with a feedback message that has a standalone format or a piggyback format as specified in the IEEE 802.16e standard. For example, the feedback message includes a bit map, which further includes a plurality of bits, e.g., 16 bits, each representing an ACK or NACK signal for one of the plurality of PDUs.

As described above, for a retransmission, the transmitter 202 may transmit a plurality of PDU partitions corresponding to a PDU for a first transmission, and the receiver 204 may only correctly receive ones of the plurality of PDU partitions. In exemplary embodiments, for the retransmission, the receiver 204 may include additional information regarding the correctly received ones of the PDU partitions in feedback information provided to the transmitter 202, as described below.

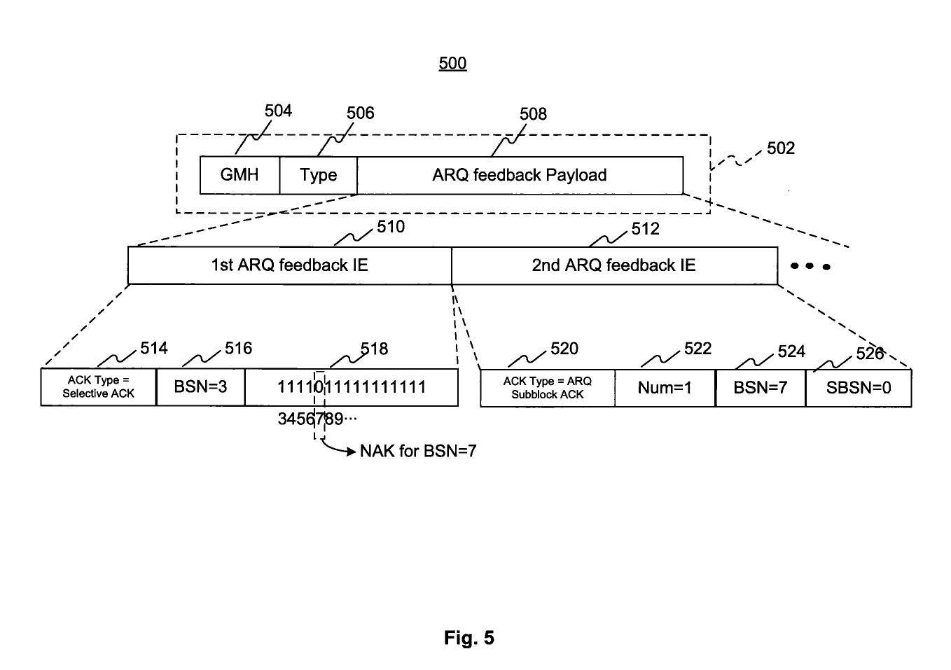

FIG. 5 illustrates a method 500 for the receiver 204 to provide feedback information to the transmitter 202, according to an exemplary embodiment. In the illustrated embodiment, it is assumed that the receiver 204 provides feedback information for sixteen ARQ blocks retransmitted from the transmitter 202, and the sixteen ARQ blocks have BSNs 3, 4, 5, 6, 7, . . . , and 18, respectively.

In exemplary embodiments, the receiver 204 determines whether or not PDU partitions corresponding to each of the sixteen ARQ blocks are correctly received. For example, if the receiver 204 determines that the PDU partitions corresponding to one of the sixteen ARQ blocks are correctly received, the receiver 204 sends an ACK signal to the transmitter 202, to indicate the PDU partitions corresponding to the one of the sixteen ARQ blocks are correctly received.

If the receiver 204 determines that not all of the PDU partitions corresponding to the one of the sixteen ARQ blocks are correctly received, the receiver 204 sends to the transmitter 202 a NACK signal to indicate not all of the PDU partitions corresponding to the one of the sixteen ARQ blocks are correctly received, together with additional information to indicate which ones of the PDU partitions corresponding to the one of the sixteen ARQ blocks are correctly received.

For example, referring to FIGS. 2 and 5, the receiver 204 sends a feedback message 502 to the transmitter 202, to provide feedback information for the sixteen ARQ blocks. The feedback message 502 may include a GMH 504, a message type (Type) 506, and an ARQ feedback payload 508. The ARQ feedback payload 508 further includes a plurality of ARQ feedback information elements (lEs), such as a first ARQ feedback IE 510 and a second ARQ feedback IE 512.

The first feedback IE 510 includes an ACK type 514, a BSN 516, and a bitmap 518. For example, the ACK type 514 indicates a format for the first ARQ feedback IE 510, such as a selective ACK format based on the BSN 516 and the bitmap 518. Also for example, the BSN 516 indicates the BSN of the first one of the sixteen ARQ blocks, i.e., the BSN 516 equals to 3. Further for example, the bitmap 518 includes sixteen bits, each representing an ACK or NACK signal for one of the sixteen ARQ blocks.

In the illustrated embodiment, the receiver 204 correctly receives all the sixteen ARQ blocks except the ARQ block with the BSN of 7. Accordingly, the bits in the bitmap 518 are all 1s, which represent the ACK signals, except that the bit for the ARQ block with the BSN of 7 is 0, which represents the NACK signal.

The second feedback IE 512 includes additional information to indicate which ones of the PDU partitions corresponding to the ARQ block with the BSN of 7 are correctly received. In the illustrated embodiment, it is assumed that the ARQ block with the BSN of 7 is the ARQ block 406 (FIG. 4), and the receiver 204 only correctly receives the first PDU partition 420 (FIG. 4) of the retransmission. Accordingly, the second feedback IE 512 includes additional information regarding the PDU partition 420.

Referring to FIGS. 4 and 5, the second feedback IE 512 may include an ACK type 520, a number (Num) 522, a BSN 524, and an SBSN 526. For example, the ACK type 520 indicates a format for the second ARQ feedback IE 512, such as an ARQ subblock ACK format based on the Num 522, the BSN 524, and the SBSN 526. Also for example, the Num 522 indicates a number of correctly received PDU partitions. In the illustrated embodiment, the receiver 204 only correctly receives the first PDU partition 420 and, therefore, the Num 522 equals to 1. Further for example, the BSN 524 indicates the BSN of the ARQ block 406, for which not all PDU partitions are correctly received, i.e., the BSN 524 equals to 7. As another example, the SBSN 526 indicates the SBSN of the first one of the ARQ subblocks included in the PDU partition 420, i.e., the SBSN 526 equals to 0.

Referring back to FIG. 2, in exemplary embodiments, the receiver 204 is configured to store a received ARQ block in a buffer and to purge the ARQ block until all ARQ blocks received before that ARQ block are correctly received. Typically, the transmitter 202 knows a size of the buffer in the receiver 204, such that when the transmitter 202 determines that the buffer in the receiver 204 is full, the transmitter 202 stops transmitting ARQ blocks to the receiver 204.

In exemplary embodiments, an ARQ window may be defined between the transmitter 202 and the receiver 204, to count a number of bytes that the transmitter 202 further transmits after transmitting a first ARQ block that is not positively acknowledged. A maximum length of the ARQ window, measured by a number of bytes, may be configured to be equal to or smaller than the size of the buffer in the receiver 204.

In exemplary embodiments, the transmitter 202 may accumulate a number of bytes for transmitted ARQ blocks. If the accumulated number of bytes is equal to or larger than the maximum length of the ARQ window, the transmitter 202 suspends transmitting new ARQ blocks until the transmitter 202 receives an ACK signal for the first ARQ block. When the transmitter 202 receives the ACK signal for the first ARQ block, the transmitter 202 determines a number of bytes to be subtracted and subtracts the determined number of bytes from the accumulated number of bytes. For example, the determined number of bytes may be equal to a sum of the number of bytes for the first ARQ block and the number of bytes for the following transmitted ARQ blocks that have been positively acknowledged. The transmitter 202 further resumes transmission of data, if the accumulated number of bytes after the subtraction is smaller than the maximum length of the ARQ window.

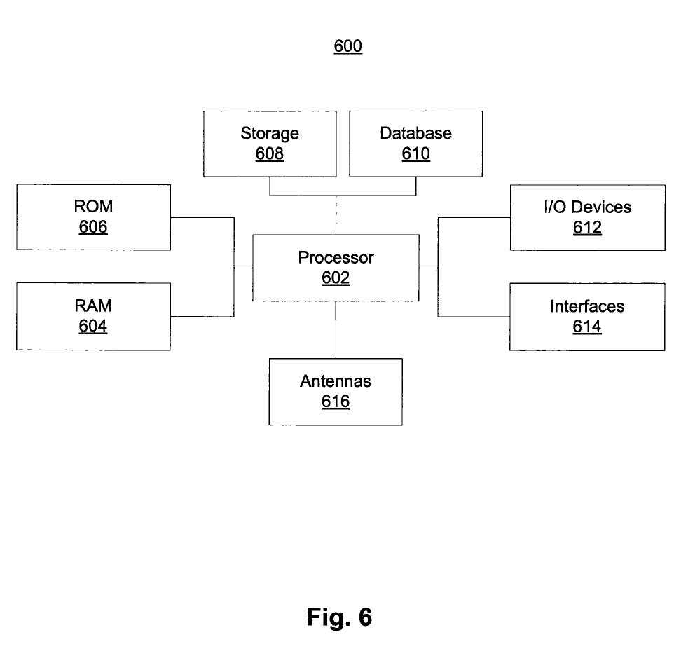

FIG. 6 illustrates a block diagram of a transmitter 600, according to an exemplary embodiment. For example, the transmitter 600 may be the transmitter 202 (FIG. 2). Referring to FIG. 6, the transmitter 600 may include one or more of the following components: a processor 602 configured to execute computer program instructions to perform various processes and methods, random access memory (RAM) 604 and read only memory (ROM) 606 configured to access and store information and computer program instructions, storage 608 to store data and information, databases 610 to store tables, lists, or other data structures, I/O devices 612, interfaces 614, antennas 616, etc. Each of these components is well-known in the art and will not be discussed further.

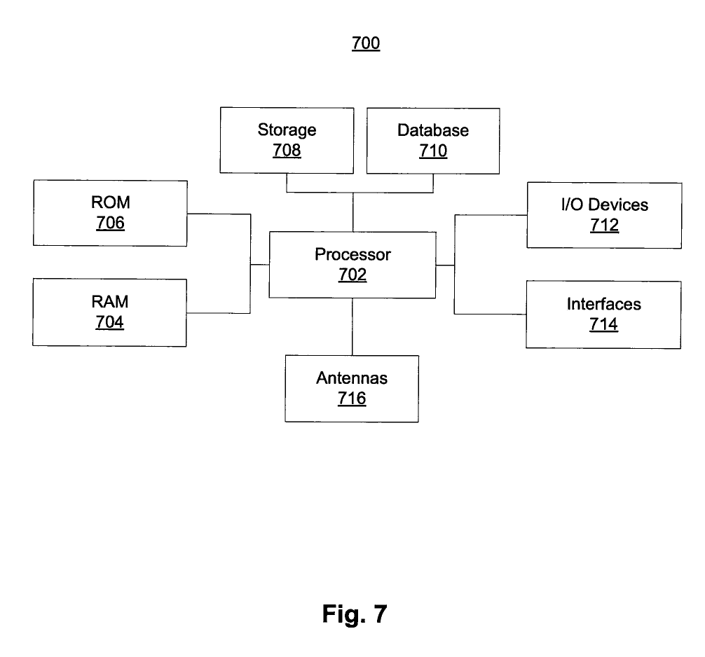

FIG. 7 illustrates a block diagram of a receiver 700, according to an exemplary embodiment. For example, the receiver 700 may be the receiver 204 (FIG. 2). Referring to FIG. 7, the receiver 700 may include one or more of the following components: a processor 702 configured to execute computer program instructions to perform various processes and methods, random access memory (RAM) 704 and read only memory (ROM) 706 configured to access and store information and computer program instructions, storage 708 to store data and information, databases 710 to store tables, lists, or other data structures, I/O devices 712, interfaces 714, antennas 716, etc. Each of these components is well-known in the art and will not be discussed further.

Other embodiments of the invention will be apparent to those skilled in the art from consideration of the specification and practice of the invention disclosed herein. The scope of the invention is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

What is claimed is:

1. A method for a transmitter to transmit data represented by a plurality of service data units (SDUs), comprising:
generating, for a first transmission, a data block from one or more of the SDUs, or from one or more fragments of the SDUs;
generating, based on a protocol, a protocol data unit (PDU) to include the data block; and
transmitting the PDU.

2. The method of claim 1, wherein the generating of the data block comprises:
packing the one or more of the SDUs, or the one or more fragments of the SDUs.

3. The method of claim 1, wherein the generating of the data block comprises:
fragmenting the SDUs.

4. The method of claim 1, further comprising:
generating, for the first transmission, a plurality of data blocks;
sequentially numbering the plurality of data blocks;
generating, based on the protocol, a plurality of PDUs, each including one of the sequentially numbered data blocks; and
transmitting the PDUs.

5. The method of claim 4, wherein the sequentially numbering comprises:
assigning data block sequence numbers to the plurality of data blocks, respectively.

6. The method of claim 1, further comprising:
retransmitting the data block without rearrangement.

7. The method of claim 6, wherein the retransmitting comprises:
generating a retransmission PDU, the retransmission PDU including the data block and fragmentation and packing information corresponding to the first transmission.

8. The method of claim 1, further comprising:
rearranging, for a retransmission, the data block.

9. The method of claim 8, wherein the rearranging comprises:
fragmenting the data block into a plurality of data subblocks each having a fixed size;
sequentially numbering the plurality of data subblocks; and
generating a plurality of PDU partitions each including one or more of the sequentially numbered data subblocks.

10. The method of claim 9, further comprising:
transmitting, for the retransmission, the PDU partitions to transmit the data block.

11. A transmitter to transmit data represented by a plurality of service data units (SDUs), comprising:
a processor, the processor being configured to
generate, for a first transmission, a data block from one or more of the SDUs, or from one or more fragments of the SDUs;
generate, based on a protocol, a protocol data unit (PDU) to include the data block; and
transmit the PDU.

12. The transmitter of claim 11, wherein the processor is further configured to:
generate, for the first transmission, a plurality of data blocks;
sequentially number the plurality of data blocks;
generate, based on the protocol, a plurality of PDUs, each including one of the sequentially numbered data blocks; and
transmit the PDUs.

13. The transmitter of claim 11, wherein the processor is further configured to:
retransmit the data block without rearrangement.

14. The transmitter of claim 13, wherein the processor is further configured to:
generate a retransmission PDU, the retransmission PDU including the data block and fragmentation and packing information corresponding to the first transmission.

15. The transmitter of claim 11, wherein the processor is further configured to:
rearrange, for a retransmission, the data block.

16. The transmitter of claim 15, wherein the processor is further configured to:
fragment the data block into a plurality of data subblocks each having a fixed size;
sequentially numbering the plurality of data subblocks; and
generate a plurality of PDU partitions each including one or more of the sequentially numbered data subblocks.

17. A method for a receiver to provide feedback information for data received from a transmitter, the data being represented by a plurality of protocol data unit (PDU) partitions from a PDU, the method comprising:
sending, if not all of the PDU partitions are correctly received, a negative acknowledgment (NACK) to the transmitter, to indicate that not all of the PDU partitions are correctly received; and
sending additional information to the transmitter to indicate which ones of the PDU partitions are correctly received.

18. The method of claim 17, further comprising:
sending, if all of the PDU partitions are correctly received, an acknowledgment (ACK) to the transmitter.

19. A receiver to provide feedback information for data received from a transmitter, the data being represented by a plurality of protocol data unit (PDU) partitions from a PDU, the receiver comprising:
a processor, the processor being configured to
send, if not all of the PDU partitions are correctly received, a negative acknowledgment (NACK) to the transmitter, to indicate that not all of the PDU partitions are correctly received; and
send additional information to the transmitter to indicate which ones of the PDU partitions are correctly received.

20. The receiver of claim 19, wherein the processor is further configured to:
send, if all of the PDU partitions are correctly received, an acknowledgment (ACK) to the transmitter.

21. A method for a transmitter to transmit data to a receiver, the receiver including a buffer for receiving the data, the method comprising:
accumulating a number of bytes for transmitted data after a first transmitted data block is not acknowledged by the receiver;
suspending transmission of data, if the accumulated number of bytes is equal to or larger than a number of bytes determined based on a size of the buffer;
determining a number of bytes to be subtracted and subtracting the determined number of bytes from the accumulated number of bytes, when receiving an acknowledgement by the receiver of the first transmitted data block; and
resuming transmission of data, if the accumulated number of bytes after the subtraction is smaller than the number of bytes determined based on the size of the buffer.

22. The method of claim 21, further comprising:
transmitting data based on an automatic repeat request (ARQ) scheme.
